(19) United States
(12) Patent Application Publication
(10) Pub. No.: US 2020/0041745 A1
(43) Pub. Date: Feb. 6, 2020

(54) LENS AND LENS MODULE INCLUDING THE SAME

(71) Applicant: AAC Technologies Pte. Ltd., Singapore city (SG)

(72) Inventor: Hailong Wang, Shenzhen (CN)

(21) Appl. No.: 16/528,562

(22) Filed: Jul. 31, 2019

(30) Foreign Application Priority Data
Aug. 6, 2018 (CN) 201821263296.6

(51) Int. Cl. G02B 7/02

(52) U.S. Cl. CPC G02B 7/02

(57) ABSTRACT

The present disclosure relates to the field of optical imaging technologies, and provides a lens and a lens module including the lens. The lens includes: an optical portion located at a central position; a bearing portion surrounding the optical portion; and a plurality of reinforcing portions embedded in the bearing portion for reinforcing rigidity of the bearing portion. The plurality of reinforcing portions is spaced apart from each other around an optical axis. The lens and the lens module including the same provided by the present disclosure can enhance the ability to resist deformation of the lens, and improve the assembly stability of the lens module, thereby improving the yield of the lens module.

### TECHNICAL FIELD

The present disclosure relates to the field of optical imaging technologies, and in particular, to a lens and a lens module including the same.

### BACKGROUND

With the continuous development of technology, electronic devices become more and more intelligent. In addition to digital cameras, portable electronic devices such as tablet PC and mobile phones are also equipped with lens modules having a photographing function in order to meet the users' requirements to take photos at any time. In the related art, a lens module includes a plurality of lenses that are abutted against and fixed to each other.

The inventors have found that at least the following problems exist in the related art. The lens in the lens module may deform by extrusion of the adjacent optical assembly, so that the assembling stability of the lens module is not high, thereby reducing the yield of the lens module.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a perspective schematic structural view of a lens according to a first embodiment of the present disclosure;

FIG. 2 is a top view of a lens according to a first embodiment of the present disclosure;

FIG. 3 is a side view of a lens according to a first embodiment of the present disclosure;

FIG. 4 is a side view of a lens according to a second embodiment of the present disclosure; and

FIG. 5 is a cross-sectional structural view of a lens module according to a third embodiment of the present disclosure.

### DESCRIPTION OF EMBODIMENTS

The present disclosure will be further illustrated with reference to the accompanying drawings and the embodiments.

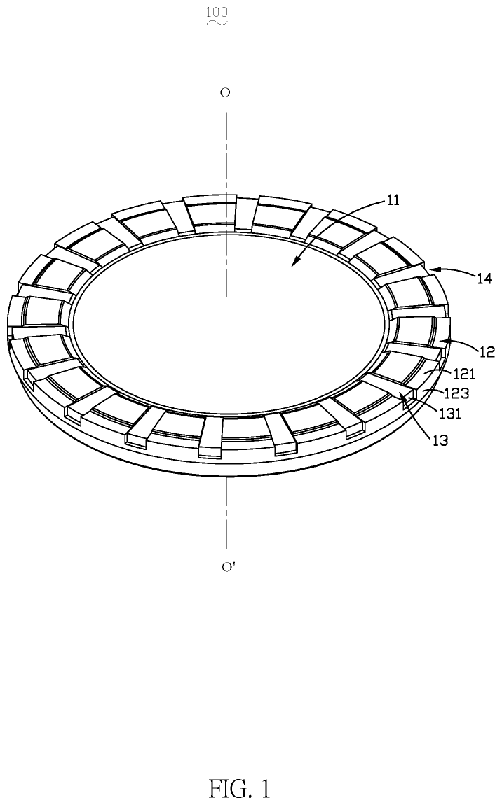

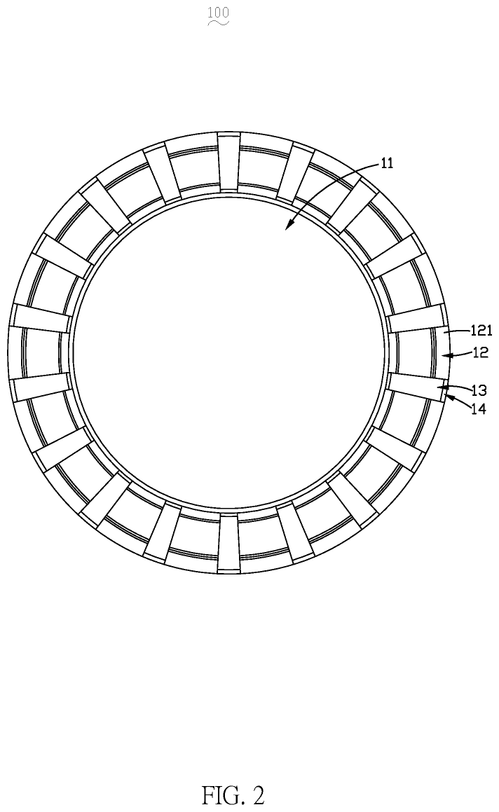

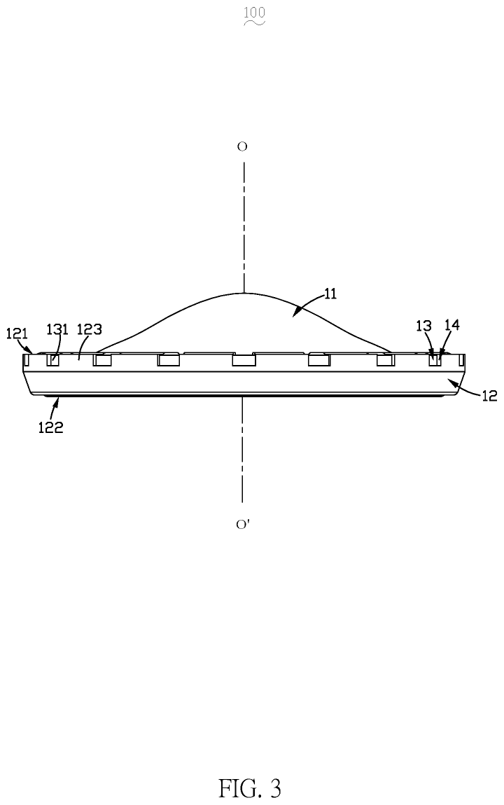

A first embodiment of the present disclosure provides a lens 100. As shown in FIGS. 1 to 3, the lens 100 includes: an optical portion 11, a bearing portion 12, and a reinforcing portion 13. The optical portion 11 is located at a central position. The bearing portion 12 surrounds the optical portion 11. The reinforcing portion 13 is embedded in the bearing portion 12 and configured to reinforce the rigidity of the bearing portion 12. A plurality of reinforcing portions 13 is spaced apart from each other around an optical axis OO′.

Compared with the related art, in this embodiment, the reinforcing portion 13 is embedded in the bearing portion 12 and configured to reinforce the rigidity of the bearing portion 12, so that the ability to resist deformation of the lens 100 is enhanced, thereby improving the stability in assembly of the lens module, improving the yield of the product and saving the production cost. Meanwhile, since a plurality of reinforcing portions 13 is spaced apart from each other around the optical axis OO′, a shape of the reinforcing portion 13 can be more flexible and the lower manufacturing precision is required, thereby improving the convenience of processing.

As an example, the plurality of reinforcing portions 13 is equally spaced around the optical axis OO′. In this way, the ability of the bearing portion 12 to withstand the force can be more uniformly enhanced, thereby further enhancing the ability to resist deformation of the lens 100.

In this embodiment, the optical portion 11 and the bearing portion 12 are made of a plastic material; the reinforcing portion 13 is made of a metal material; and the bearing portion 12 and the reinforcing portion 13 are formed into one piece. During a molding process of a plastic lens 100, an annular metal block and a plastic part are directly fused together, so that the metal block can be fixed in the plastic lens 100. In this way, the ability to resist deformation can become stronger due to the existence of the metal block in the bearing portion 12 of the resulting lens 100, thereby improving the mechanical imbalance of the lens 100. Since the lens 100 has been directly fixed to the reinforcing portion 13 during the molding process, there is no need to additionally fix the reinforcing portion 13, which simplifies the manufacturing process and saves production cost. Moreover, this makes the fixation between the bearing portion 12 and the reinforcing portion 13 tighter, thereby further improving the ability to resist deformation of the lens 100. In addition, the metal reinforcing portion 13 can greatly improve the rigidity of the bearing portion 12, and the material is convenient to obtain and process. Since the plastic material has a high light transmittance and a low melting point and is easy to mold, the optical portion 11 and the bearing portion 12 adopting the plastic material can ensure the optical performance of the lens 100 and are easy to process.

In an example, the bearing portion 12 includes a first surface 121 and a second surface 122 that are opposite to each other. The bearing portion 12 is provided with a recessed portion 14 recessed from the first surface 121 towards the second surface 122. The reinforcing portion 13 is fixed in the recessed portion 14. Since the recessed portion 13 is recessed from the first surface 121 towards the second surface 122 and the reinforcing portion 13 is provided in the recessed portion 14, the reinforcing portion 13 is exposed out of the first surface of the bearing portion 12, so that the reinforcing portion 13 can be conveniently fixed in the recessed portion 14, thereby increasing the convenience of the manufacturing process.

It can be understood that the recessed portion may also extend from the second surface 122 towards the first surface 121. Alternatively, one part of the recessed portion extends from the first surface 121 towards the second surface 122, and the other part of the recessed portion extends from the second surface 122 towards the first surface 121. Both of them can achieve a same technical effect, and will not be elaborated herein.

Further, the bearing portion 12 further includes a peripheral surface 123 connecting the first surface 121 with the second surface 122. The recessed portion 14 extends from the peripheral surface 123 towards the optical axis OO′. Since the recessed portion 14 extends from the peripheral surface 123 towards the optical axis OO′, the reinforcing portion 13 is also exposed out of the peripheral surface 123 of the bearing portion 12, so that the reinforcing portion 13 can be fixed more conveniently during the molding of the plastic portion of the lens 100, thereby further increasing the convenience of the manufacturing process.

Optionally, the reinforcing portion 13 includes an outer side surface 131 that is parallel to the optical axis OO′ and faces away from the optical axis OO′. The outer side surface 131 is flush with the peripheral surface 123. In this way, there is no hollow portion at the edge of the bearing portion 12, thereby further improving the ability to resist deformation of the lens 100.

In this embodiment, the reinforcing portion 13 has equal distances from the first surface 121 and the second surface 122 in a direction parallel to the optical axis. Since the reinforcing portion 13 is located at the center of the bearing portion 12 in the direction of the optical axis OO′, the bearing portion 12 has a thicker abutting portion on the upper and lower sides of the reinforcing portion 13, so that the reinforcing portion 13 can be firmly fixed in the bearing portion 12, thereby improving the reliability of the lens 100.

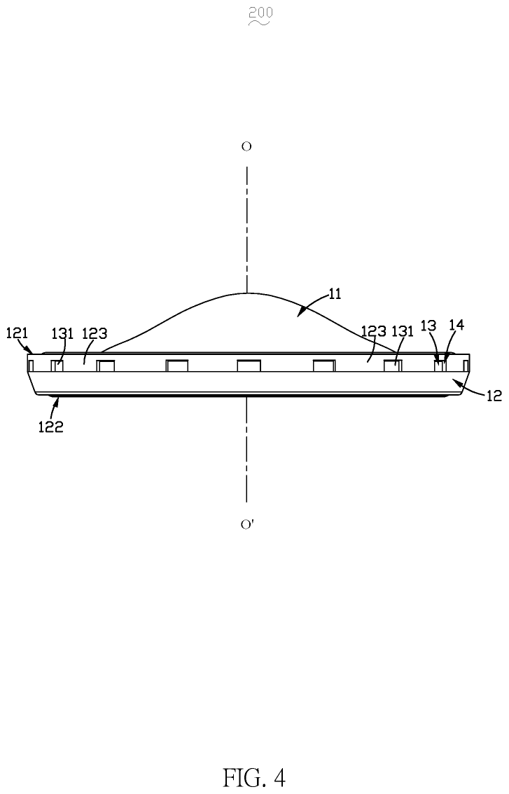

A second embodiment of the present disclosure provides a lens 200. As shown in FIG. 4, the second embodiment is substantially the same as the first embodiment. The main difference lies in that in the first embodiment, the bearing portion 12 is provided with the recessed portion 14 extending from the first surface 121 towards the second surface 122, and the reinforcing portion 13 is fixed in the recessed portion 14, that is, the reinforcing portion 14 is exposed out of the first surface 121; while in the second embodiment of the present disclosure, the reinforcing portion 13 is located between the first surface 121 and the second surface 122 in a direction parallel to the optical axis OO′ and is not exposed out of the first surface 121. Since the recessed portion 14 is recessed from the first surface 121 towards the second surface 122, and the reinforcing portion 13 is provided in the recessed portion 14, the reinforcing portion 13 is exposed out of the first surface 121 of the bearing portion 12, so that the reinforcing portion 13 is fixed more conveniently during the molding of the plastic portion of the lens 200, thereby increasing the convenience of the manufacturing process.

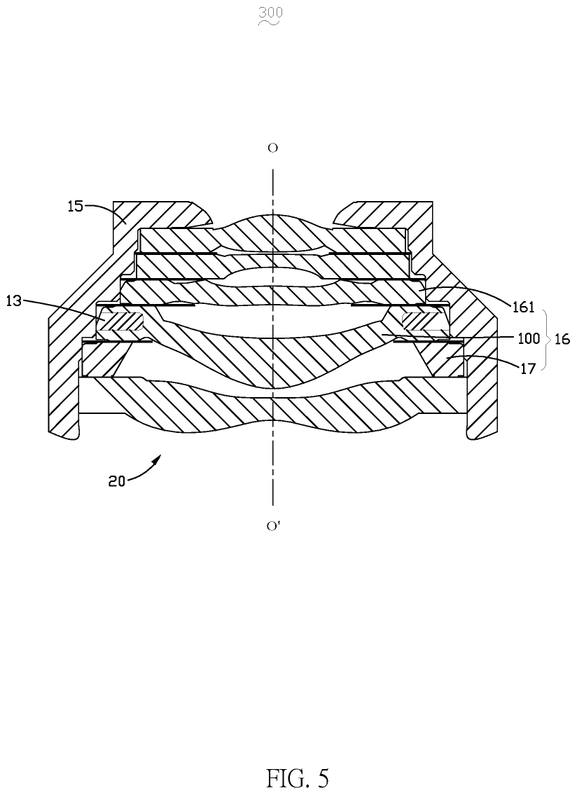

A third embodiment of the present disclosure provides a lens module 300. As shown in FIG. 5, the lens module 300 includes a lens barrel 15 having a receiving space 20, and an optical assembly received in the receiving space 20. The optical assembly includes a first lens 161 close to an object side, a light shading plate 17 provided at an image side of the first lens 161 and the lens 100, and the lens 100 is provided between the first lens 161 and the light shading plate 17. In this embodiment, the first surface is an image-side surface, and the second surface is an object-side surface. In other embodiments, the first surface may be the object-side surface, and the second surface may be the image-side surface.

In this embodiment, the reinforcing portion 13 has equal distances from the first surface 121 and the second surface 122 in a direction parallel to the optical axis. Since the reinforcing portion 13 is located at the center of the bearing portion in the direction of the optical axis OO′, the bearing portion has a thicker abutting portion on the upper and lower sides of the reinforcing portion 13, so that the reinforcing portion 13 can be firmly fixed in the bearing portion, thereby improving the reliability of the lens 100. In other embodiments, the reinforcing portion may also be exposed out of the first surface or exposed out of the second surface.

In this embodiment, the lens module is a small-head lens module. Since an optical assembly in the small-head lens module has a smaller diameter as getting closer to the object side, an extruding force applied by the first lens 161 against the lens 100 and an extruding force applied by the light shading plate 17 against the lens 100 are not in a straight line and cannot be counteracted. Then, the lens 100 is easily twisted under the two extruding forces, and the lens 100, in particular, the plastic lens may deform, since the plastic lens may easily deform due to the small rigidity and high deformability of the plastic. The lens deformation may cause the lens module to be very instable when the lens module is being assembled in practice, thereby affecting the performance of the lens module and reducing the yield of the product. In this embodiment, by embedding the reinforcing portion in the bearing portion for enhancing the rigidity of the bearing portion, the rigidity of the lens 100 is further improved, and the deformation of the lens 100 is reduced, thereby improving the stability of the lens module 200 during an assembling process and improving the yield of the product.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. A lens, comprising:
an optical portion located at a central position;
a bearing portion surrounding the optical portion; and
a plurality of reinforcing portions embedded in the bearing portion for reinforcing rigidity of the bearing portion,
wherein the plurality of reinforcing portions is spaced apart from each other around an optical axis.

2. The lens as described in claim 1, wherein the plurality of reinforcing portions is equally spaced around the optical axis.

3. The lens as described in claim 1, wherein the bearing portion comprises a first surface and a second surface that are opposite to each other, the bearing portion is provided with a plurality of recessed portions each formed by recessing from the first surface towards the second surface, and the plurality of reinforcing portions is fixed in the plurality of recessed portions.

4. The lens as described in claim 3, wherein the bearing portion further comprises a peripheral surface connecting the first surface with the second surface, and each of the plurality of recessed portions extends from the peripheral surface towards the optical axis.

5. The lens as described in claim 1, wherein the bearing portion comprises a first surface and a second surface that are opposite to each other, and the plurality of reinforcing portions is located between the first surface and the second surface in a direction parallel to the optical axis and not exposed out of the first surface.

6. The lens as described in claim 5, wherein the plurality of reinforcing portions has equal distances from the first surface and the second surface in the direction parallel to the optical axis.

7. The lens as described in claim 1, wherein each of the plurality of reinforcing portions is made of a metal material.

8. The lens as described in claim 7, wherein the bearing portion and the plurality of reinforcing portions are formed into one piece.

9. A lens module, comprising the lens as described in claim 1.

10. The lens module as described in claim 9, wherein the plurality of reinforcing portions is equally spaced around the optical axis.

11. The lens module as described in claim 9, wherein the bearing portion comprises a first surface and a second surface that are opposite to each other, the bearing portion is provided with a plurality of recessed portions each formed by recessing from the first surface towards the second surface, and the plurality of reinforcing portions is fixed in the plurality of recessed portions.

12. The lens module as described in claim 11, wherein the bearing portion further comprises a peripheral surface connecting the first surface with the second surface, and each of the plurality of recessed portions extends from the peripheral surface towards the optical axis.

13. The lens module as described in claim 9, wherein the bearing portion comprises a first surface and a second surface that are opposite to each other, and the plurality of reinforcing portions is located between the first surface and the second surface in a direction parallel to the optical axis and not exposed out of the first surface.

14. The lens module as described in claim 13, wherein the plurality of reinforcing portions has equal distances from the first surface and the second surface in the direction parallel to the optical axis.

15. The lens module as described in claim 9, wherein each of the plurality of reinforcing portions is made of a metal material.

16. The lens module as described in claim 9, wherein the bearing portion and the plurality of reinforcing portions are formed into one piece.

17. A lens module as described in claim 9, comprising:
a lens barrel having a receiving space; and
an optical assembly received in the receiving space,
wherein the optical assembly comprises a first lens close to an object side, a light shading plate provided at an image side of the first lens, and the lens being provided between the first lens and the shading plate.
